(19) United States
(12) Patent Application Publication
(10) Pub. No.: US 2015/0188948 A1
(43) Pub. Date: Jul. 2, 2015

(54) METHOD AND SYSTEM FOR BLOCKING CONTENT

(71) Applicant: Samsung Electronics Co., Ltd., Gyeonggi-do (KR)

(72) Inventors: Jihwan SONG, Gyeonggi-do (KR); Eunyoung KWON, Seoul (KR); Michael PAK, Seoul (KR); Ilwoong JEONG, Gyeonggi-do (KR); Hyunsoo KIM, Gyeonggi-do (KR); Gajin SONG, Gyeonggi-do (KR)

(73) Assignee: Samsung Electronics Co., Ltd.

(21) Appl. No.: 14/586,405

(22) Filed: Dec. 30, 2014

(30) Foreign Application Priority Data
Dec. 30, 2013 (KR) 10-2013-0167247

(51) Int. Cl. H04L 29/06

(52) U.S. Cl. CPC H04L 63/20

(57) ABSTRACT

A content blocking method of a user device is provided. The method includes receiving a policy from a profile server; receiving a content access request; determining a category where content corresponding to the access request belongs; and blocking the content corresponding to the access request, if the determined category corresponds to a category that is set to be blocked in the policy.

### PRIORITY

This application claims priority under 35 U.S.C. §119(a) of to a Korean Patent Application filed on Dec. 30, 2013 in the Korean Intellectual Property Office and assigned Serial No. 10-2013-0167247, the entire contents of which is incorporated herein by reference.

### BACKGROUND

1. Field of the Invention

The present invention relates generally to a content blocking method and system for adaptively blocking objectionable content, and more particularly, to a content controlling system and method for classifying objectionable content, and adaptively update the criteria for objectionable content through feedback with a user.

2. Description of the Related Art

As information communication technologies have developed, various user devices have been developed. Accordingly, a user may now download various contents through an open market, or the like, using a user device.

However, as various content is downloaded to the user device, harmful content may be provided to the user. For example, juveniles readily access content, such as an objectionable image, video, and the like, via a web browser or the like. Even though they do not access the objectionable content intentionally, objectionable content may be downloaded together with useful content so that juveniles may be exposed to them.

According to a conventional method for blocking objectionable content, when a Uniform Resource Locator (URL) where objectionable content is located is input from a user device, whether the input URL is identical to a URL that is defined in advance as including objectionable content, is determined. When it is determined that they are identical, access to the input URL is blocked. Alternatively, the conventional method uses a scheme of uniformly blocking objectionable content corresponding to a predetermined category, such as a drug, hacking, gambling, religion, and the like.

However, the above described conventional art has a drawback in that it fails to reflect diversity in association with maleficence of content, such as cultural and local characteristics, or the like. For example, when a category of content that a user desires to use is underwear, whether the content is objectionable is often dependent upon a country of the user. In addition, a religion category may be defined as an objectionable content category for a race and a country having a predetermined culture, but may be defined as useful information for a race and a country having another culture. In addition, the conventional art has a drawback in that criteria for filtering objectionable content are inadaptable.

### SUMMARY

The present invention has been made to address the above-mentioned problems and disadvantages, and to provide at least the advantages described below. Accordingly, an aspect of the present invention provides a method and a system for adaptively blocking objectionable content .In accordance with an aspect of the present invention, there is provided a method of a user device to block a content. The method includes receiving a policy from a profile server; receiving a content access request; determining a category where a content corresponding to the access request belongs; determining whether the determined category corresponds to a category that is set to be blocked in the policy; and blocking the content corresponding to the access request when the determined category corresponds to the category included in the policy.

In accordance with another aspect of the present invention, there is provided a content blocking system. The content blocking system includes a profile server configured to set a policy and transmit the set policy; and a first user device configured to receive the set policy from the profile server, receive a content access request, determine a category where the content corresponding to the access request belongs, determine whether the determined category corresponds to a category that is set to be blocked in the policy, and block the content corresponding to the access request when the determined category corresponds to the category included in the policy.

### BRIEF DESCRIPTION OF THE DRAWINGS

The above and other aspects, features, and advantages of certain embodiments of the present invention will be more apparent from the following description, taken in conjunction with the accompanying drawings, in which:

FIG. 1 is a diagram illustrating a content blocking system according to an embodiment of the present invention;

FIG. 2 is a flowchart illustrating a content blocking method of a content blocking system according to an embodiment of the present invention;

FIG. 3 is a diagram illustrating a content blocking system according to an embodiment of the present invention;

FIG. 4 is a flowchart illustrating a content blocking method of a content blocking system according to an embodiment of the present invention;

FIGS. 5A and 5B are block diagrams illustrating a first user device according to an embodiment of the present invention;

FIG. 6 is a block diagram illustrating a profile server according to an embodiment of the present invention;

FIG. 7 is a block diagram illustrating a second user device according to an embodiment of the present invention;

FIG. 8 is a flowchart illustrating a content blocking method of a first user device according to an embodiment of the present invention; and

FIG. 9 is a flowchart illustrating a content blocking method of a first user device according to an embodiment of the present invention.

### DETAILED DESCRIPTION OF EMBODIMENTS OF THE PRESENT INVENTION

Before describing embodiments of the present invention, a “first user device” is defined as an electronic device of which access to a content is controlled by a “second user device” (or manager device).

The “second user device” is defined as an electronic device configured to control the first user device's access to content, and to manage at least one first user device based on a group, which may be interchangeably used as a manager device.

“Policy” is defined as criteria for determining whether to block a category including at least one content.

The first user device and the second user device (or manager device), according to an embodiment of the present invention, each include a computing resource, and may include, for example, a smart phone table Personal Computer (PC), a digital camera, a computer monitor, a Personal Digital Assistant (PDA), an electric scheduler, a desktop PC, a Portable Multimedia Player (PMP), a Media Player (for example, a Moving Picture Experts Group Audio Layer 3 (MP3) player), an audio equipment, a wrist watch, a game terminal, or the like.

Hereinafter, various embodiments of the present invention are described in detail with reference to the accompanying drawings. It should be noted that the same elements will be designated by the same reference numerals although they are shown in different drawings. Further, a detailed description of a known function and configuration which may make the subject matter of the present invention unclear is omitted. Hereinafter, it should be noted that only the descriptions that may help understanding of the operations provided in association with the various embodiments of the present invention are provided, and other descriptions are omitted to avoid obfuscating the subject matter of the present invention.

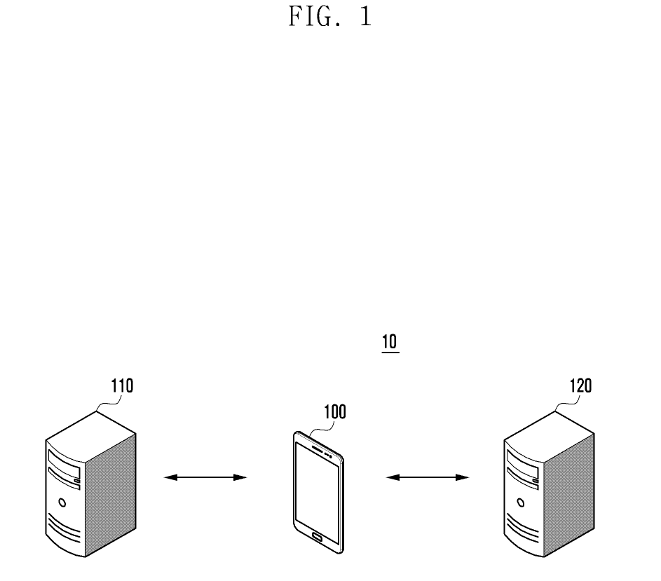

FIG. 1 is a diagram illustrating a content blocking system according to an embodiment of the present invention.

Referring to FIG. 1, a content blocking system 10 may include a first user device 100, a content classification server 110, and a profile server 120.

The first user device 100 receives a content access (or access) request input from a user, and may block or allow content corresponding to the access request based on whether a category where the content corresponding to the access request belongs is included in a default policy. In particular, the first user device 100 may transmit information associated with the content to the content classification server 110, so as to determine the category where the content corresponding to the access request belongs. After determining the category where the content belongs from the content classification server 110, the first user device 100 may determine whether the category where the content belongs is identical to a category included in the policy. When it is determined that the category including the content corresponding to the access request is identical to the category included in the policy, the first user device 100 may block the content corresponding to the access request. Conversely, when it is determined that the category including the content corresponding to the access request is different from the category included in the policy, the first user device 100 may allow access to the content corresponding to the access request. For example, when a user inputs a predetermined Uniform Resource Locator (URL) for access to a content, the first user device 100 may transmit information associated with the predetermined URL to the content classification server 110. The first user device 100 may receive category information (for example, a crime related site category) from the content classification server 110, and may determine whether the received category is identical to the category included in the policy. When it is determined that the category is identical to the category included in the policy, the first user device 100 may block access to the predetermined URL. Conversely, when it is determined that the category is different from the category included in the policy, the first user device 100 may allow access to the predetermined URL.

In addition, when the content corresponding to the access request has a record of being blocked during a predetermined period, the first user device 100 may immediately block the content corresponding to the access request, without determining the category where the content corresponding to the access request belongs. For example, when a predetermined URL has a record of being blocked and access to the predetermined URL is requested again from the user, the first user device 100 may block access to the predetermined URL without determining a category where the predetermined URL belongs via the content classification server 110. Through the above, objectionable content may be promptly blocked.

When information associated with the content is received from the first user device 100, the content classification server 110 may determine the category where the content belongs. In particular, the content classification server 110 may search a content classification database (DB) for determining the category where the content belongs. For example, when a request for determining a category of “www.XXX.com” is received from the first user device 100, the content classification server 110 may search for a category where “www.XXX.com” belongs (for example, a portal site, a predetermined religion site, a gambling site, or the like) through the content classification DB. The content classification server 110 may determine the category where “www.XXX.com” belongs via a search, and may transmit determined category information to the first user device 100.

The profile server 120 may set a default policy, and transmits the set default policy to the first user device 100. In this case, for ease of description, the default policy is defined as a policy that is not modified by the second user device (or manager device), and when the default policy is modified by the second user device, the policy may be defined as a modified policy. The profile server 120, according to an embodiment of the present invention, may set the default policy by reflecting various characteristics. In particular, the profile server 120 may set the default policy by reflecting a regional division, for example, an administrative district such as a nation, a city, a province, and the like, and a cultural region division based on a predetermined cultural characteristic, and detailed characteristics such as an age, a gender, an occupation, a religion, and the like of users of the first user device 100 and the second user device. For example, the profile server 120 may determine whether to include a predetermined religion (for example, Islam) in the default policy based on a cultural background of the user of the first user device 100, and may determine whether to include an alcohol category, a cigarette category, and the like in the default policy based on the age of the user (for example, a person under age) of the first user device 100. The profile server 120 may transmit the default policy to the first user device 100. The default policy transmitted to the first user device 100 may be provided in the form of a list including information associated with whether to block a category for each category.

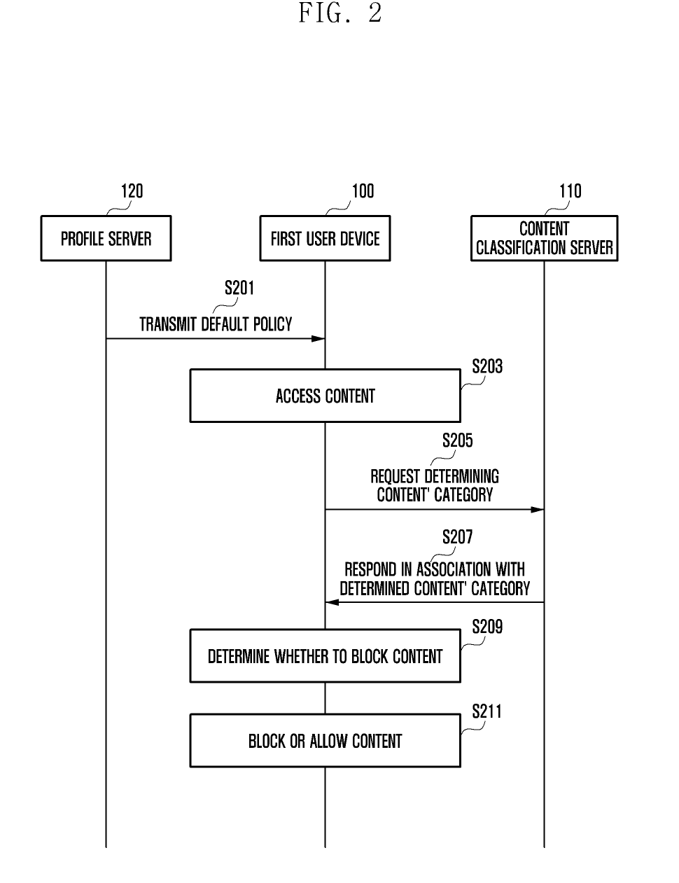

FIG. 2 is a flowchart illustrating a content blocking method of a content blocking system according to an embodiment of the present invention.

Referring to FIG. 2, in operation 201, the profile server 120 transmits a default policy to the first user device 100. The default policy may be provided in a form of a list which includes information associated with whether to block a category for each category.

Although not illustrated in FIG. 2, before operation 201, a user of the first user device 100 may transmit, to the profile server 120, information associated with the first user device 100 and user information of the first user device 100, for example, a region of residence, an age, and the like, for subscribing to, or registering with, a content blocking service according to an embodiment of the present invention.

In operation 203, the first user device 100 receives an input for accessing content. For example, the user of the first user device 100 may execute an application, an Internet browser, and the like and may input a file path or a URL where a predetermined content is located, so as to access the predetermined content.

When the input for accessing the content is received from the user in operation 203, the first user device 100 may transmit content information to the content classification server 110 so as to determine a category of the content in operation 205. Alternatively, in an embodiment of the present invention, the first user device 100 may determine whether the content corresponding to the access request has a record of being blocked within a predetermined period. When the determination shows that the content corresponding to the access request has a record of being blocked within a predetermined period, the first user device 100 may immediately block the content corresponding to the access request without determining the category where the content corresponding to the access request belongs. Conversely, when it is determined that the content corresponding to the access request does not have a record of being blocked within a predetermined period, the first user device 100 may transmit, to the content classification server 110, content information of the content corresponding to the access request.

In operation 207, the content classification server 110 determines a category where the content corresponding to the access request belongs, based on the content information received from the first user device 100, and transmits the same to the first user device 100. In particular, the content classification server 110 may search a content classification database (DB) to determine the category where the content belongs. The content classification server 110 may determine the category where the content corresponding to the access request belongs via a search, and may transmit the determined category to the first user device 100.

In operation 209, the first user device 100 receives category information of the category where the content corresponding to the access request belongs, from the content classification server 110, and may determine whether to block the content corresponding to the access request. In particular, the first user device 100 determines whether to block the content corresponding to the access request, based on whether the category where the content corresponding to the access request belongs is identical to a category set to be blocked in the default policy.

In operation 211, the first user device 100 may block or allow access to the content corresponding to the access request. In particular, when the category where the content corresponding to the access request belongs is identical to the category set to be blocked in the default policy, the content corresponding to the access request may be blocked. For example, when it is determined that a URL where the content corresponding to the access request is located belongs to a drug category and the drug category is set to be blocked in the default policy, the first user device 100 may block the content corresponding to the access request. As another example, when it is determined that a path where the content corresponding to the access request is located belongs to a corporate secret category and the corporate secret category is set to be blocked in the default policy, the first user device 100 may block the content corresponding to the access request. However, the above is merely an example. In other words, the default policy provided from the profile server 120 may be different for each first user device 100 and thus, whether the first user device 100 blocks a content or not may be changed. For example, when the user of the first user device 100 is a person who needs a drug to give medical treatment to patients, such as a doctor or the like, the default policy provided from the profile server 120 may be set to allow the drug category. Accordingly, although a URL where a content corresponding to an access request from the first user device 100 is located belongs to the drug category, the user device 100 may allow access to the content. Conversely, when the category where the content corresponding to the access request belongs is different from a category set to be blocked in the default policy, the first user device 100 may allow the access to the content corresponding to the access request.

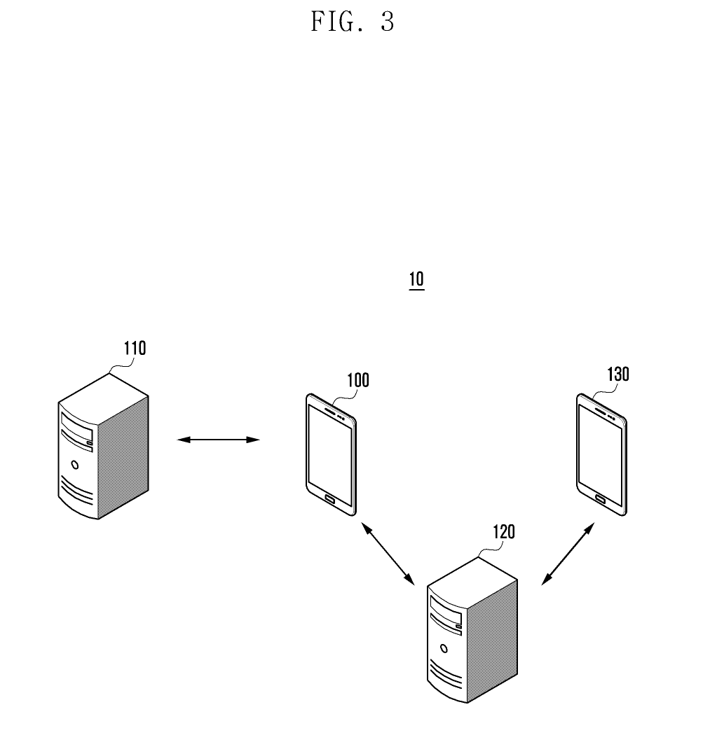

FIG. 3 is a diagram illustrating a content blocking system according to an embodiment of the present invention.

Referring to FIG. 3, the content blocking system 10 may include the first user device 100, a content classification providing server, the profile server 120, and a second user device 130 (or manager device).

The first user device 100 receives a content access request input from a user, and may block or allow content corresponding to the access request, based on whether a category where the content corresponding to the access request belongs is included in a modified policy. Here, the modified policy may be defined as a policy that is obtained through modifying the default policy set in the profile server 120, by the second user device 130. After determining the category where the content belongs from the content classification server 110, the first user device 100 may determine whether the category where the content belongs is included in the modified policy. When it is determined that the category including the content corresponding to the access request is identical to a category included in the modified policy, the first user device 100 may block the content corresponding to the access request. Conversely, when it is determined that the category including the content corresponding to the access request is different from the category included in the policy, the first user device 100 may allow access to the content corresponding to the access request. In addition, when the content corresponding to the access request has a record of being blocked during a predetermined period, the first user device 100 may immediately block the content corresponding to the access request, without determining the category where the content corresponding to the access request belongs.

The first user device 100, according to an embodiment of the present invention, may request unblocking a content included in a category that is set to be blocked in the modified policy, and thus, may access the content. In particular, the user of the first user device 100 may desire to access a content corresponding to a category that is set to be blocked in the default policy or the modified policy, or a content having a record of being blocked within a predetermined period. In this instance, the first user device 100 may request, via the profile server 120, the second user device 130 (or manager device) unblock the corresponding content. When the second user device 130 allows unblocking of the content that is set to be blocked, and a modified policy obtained by modifying the default policy or a re-modified policy obtained by modifying the modified policy is received from the profile server 120 or information associated with unblocking the content corresponding to the request for unblocking and the category where the content belongs is received, the first user device 100 may unblock the content and allows access to the content. Conversely, when the second user device 130 rejects unblocking of the content that is set to be blocked, the first user device 100 may maintain a blocking setting for the content that is set to be blocked.

When the content that is set to be blocked has a record of being blocked within a predetermined period, a request for unblocking from the first user device 100 may be automatically executed. In other words, when the first user device 100 receives a content access input, and blocks content corresponding to the access request since the content has a record of being blocked within a predetermined period, the first user device 100 may automatically transmit a request for unblocking to the second user device 130 via the profile server 120.

When information associated with the content is received from the first user device 100, the content classification server 110 may determine the category where the content belongs. In particular, the content classification server 110 may search a content classification database (DB) to determine the category where the content belongs. The content classification server 110 may determine the category where the content corresponding to the access request belongs via a search, and may transmit the determined category to the first user device 100.

The profile server 120 may set the default policy, and transmit the set default policy to the second user device 130. The profile server 120 receives, from the second user device 130, a modified policy that is modified from the default policy, and transmits the same to the first user device 100. When the second user device 130 allows unblocking of a category that is set to be blocked in the default policy or the modified policy, or a predetermined content corresponding to a request for unblocking, the profile server 120 according to an embodiment of the present invention may store, in a white list, information associated with the category or the content that is allowed to be unblocked. The profile server 120 may modify the default policy that was transmitted to the first user device 100 or may re-modify the modified policy, and transmit the same to the first user device 100, so as to enable access to the category or the content that is allowed to be unblocked. Alternatively, according to an embodiment of the present invention, the profile server 120 may transmit, to the first user device 100, information associated with unblocking the content corresponding to a request for unblocking and the category where the content belongs.

The profile server 120 may update the default policy, based on content information associated with a content that is allowed to be unblocked or information associated with a category where the content that is allowed to be unblocked belongs, which is stored in the white list for a predetermined period. In particular, although a category is determined as a harmful site and is set to be blocked in the default policy, when the number of times that the second user device 130 allows unblocking is equal to a threshold number, or is greater than an average value in comparison to other categories, the profile server 120 may change the default policy to unblock the category that is set to be blocked. In addition, the profile server 120 according to an embodiment of the present invention maintains a blocking setting for a category where a content that is allowed to be unblocked belongs, and may set to add the content that is allowed to be unblocked as a separate category. For example, when a URL “www.yyy.com” where a content corresponding to a request for unblocking is located belongs to a drug category, and “www.yyy.com” is allowed to be unblocked, the profile server 120 maintains a blocking setting for the drug category in the default policy and adds “www.yyy.com” as a separate category.

In addition, when the profile server 120 receives, from the second user device 130, a modified policy that changes a blocking setting of at least one category that is set to be blocked in the default policy to an unblocking setting, the profile server 120 may store, in the white list, information associated with the category that is changed to be unblocked. The profile server 120 may change the default policy to unblock the category that is set to be blocked, based on statistics accumulated during a predetermined period, in the same manner as the content that is allowed to be unblocked.

The profile server 120 may store, in a black list, information associated with content that is changed to be blocked when the profile server 120 receives, from the second user device 130, a modified policy that changes a setting of a category that is not set to be blocked to a blocking setting. The profile server 120 may change the default policy to block a category when the number of times that the second user device 130 changes a setting into a blocking setting during a predetermined period is equal to a threshold number, or is greater than an average value in comparison to other categories. As described above, the profile server 120 may update the default policy, based on the first user device 100 or the second user device 130 during a predetermined period, or by reflecting a modification when a blocking setting is changed in the default policy or a modified policy. Through the above, the profile server 120 may adaptively cope with a change in the criteria for determining a harmful site, which varies over time. The profile server 120 may store the default policy that is classified based on a group when the second user device 130 manages the first user device 100 based on a group.

When the default policy is received from the profile server 120, the second user device 130 may set a modified policy that is modified from the received default policy, so as to manage the first user device 100. In particular, when the default policy is received from the profile server 120, the second user device 130 may set the modified policy by monitoring the default policy and changing a category that is set to be blocked in the default policy. For example, the second user device 130 may output the default policy that is provided in the form of a list including a blocking setting for a category, and may change the blocking setting in the output list. That is, when an underwear category is set to be blocked in the list, the blocking setting may be unblocked, and when a religion category is not set to be blocked, the setting may be changed to be blocked.

In addition, when a request for unblocking is received from the first user device 100 via the profile server 120, the second user device 130 monitors the same, and may allow or rejects the request for unblocking a content corresponding to the request for unblocking or a category where the content belongs.

The second user device 130 according to an embodiment of the present invention may classify the first user device 100 based on a group, so as to manage at least one first user device 100. In particular, the second user device 130 may classify at least one first user device 100 into various groups such as home, a company, a predetermined gathering, or the like, and may manage the at least one first user device 100 for each group. For example, the second user device 130 may classify the at least one first user device 100 as a home group, and may adaptively modify the default policy based on the home group. In addition, the second user device 130 may classify the at least one first user device 100 as a company group, and may adaptively modify the default policy based on the company group. For example, when the at least one first user device 100 is classified as a company group, a modified policy may be set to block the access of the company group to a category where a predetermined video belongs.

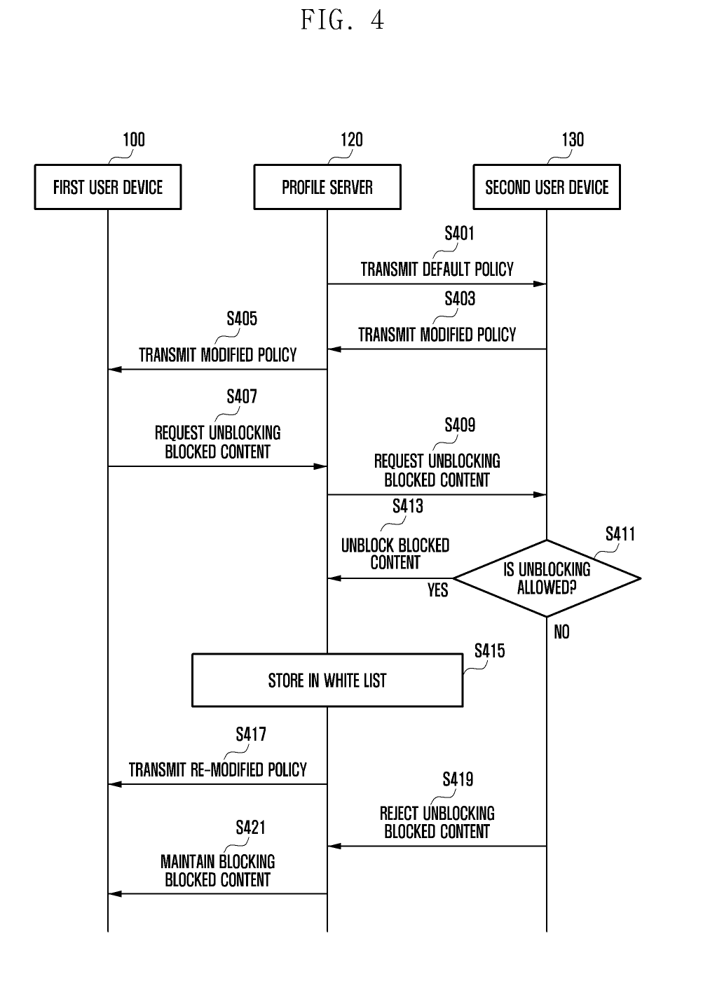

FIG. 4 is a flowchart illustrating a content blocking method of a content blocking system according to an embodiment of the present invention.

Referring to FIG. 4, in operation 401, the profile server 120 transmits a default policy to the second user device 130. In operation 403, the second user device 130 may set a modified policy by modifying the default policy, and transmits the modified policy to the profile server 120. When the modified policy is received from the second user device 130, the profile server 120 may store category information of a category of which a blocking setting in the default policy is changed. In operation 405, the second user device 130 transmits the modified policy to the first user device 100. Operation 401 and operation 403 may be omitted. In this case, the profile server 120 may transmit the default policy to the first user device 100 in operation 405.

In operation 407, the first user device 100 may request unblocking of content that is set to be blocked. In particular, the first user device 100 may transmit, to the profile server 120, information for requesting unblocking of the content that is set to be blocked. The request for unblocking of the content that is set to be blocked may be transferred to the profile server 120 automatically by the first user device 100, in addition to when a user inputs a request for unblocking to the first user device 100. In other words, the first user device 100 may block a content corresponding to an access request when it is determined that a category where the content corresponding to the access request belongs is a category that is set to be blocked in the modified policy after transmitting information associated with the category to the content classification server 110. Alternatively, when access to content that has a record of being blocked within a predetermined period is requested, the first user device 100 may block the content corresponding to the access request.

As described above, when the access request is blocked in the first user device 100, the first user device 100 may transmit, to the profile server 120, unblocking request information associated with a request for unblocking the content that is set to be blocked. In operation 409, the profile server 120 may transmit, to the second user device 130, the unblocking request information received from the first user device 100.

In operation 411, the second user device 130 may determine whether to block content corresponding to a request for blocking or a category where the content corresponding to the request for blocking belongs. When the second user device 130 allows unblocking of the content that is set to be blocked or the category where the content belongs in operation 411, the second user device 130 may transmit, to the profile server 120, information associated with unblocking of the content that is set to be blocked or the category where the content corresponding to the request for blocking belongs in operation 413.

In operation 415, the profile server 120 may store, in a white list, the information associated with unblocking the content that is set to be blocked or the category where the content corresponding to the request for blocking belongs, received from the second user device 130. The profile server 120 may update the default policy or a modified policy, based on information associated with unblocking content that is set to be blocked or a category where content corresponding to a request for blocking belongs, which is stored in a white list during a predetermined period, for example, content that is allowed to be unblocked, the number of times of allowing unblocking content that is allowed to be unblocked, a category where content that is allowed to be unblocked belongs, and the number of times of allowing unblocking a category where content that is allowed to be unblocked belongs. In operation 417, when the profile server 120 may transmit a re-modified policy that is modified from a modified policy, or may transmit a modified policy that is modified from the default policy to the first user device 100 when operation 410 and operation 403 are omitted and the default policy is transmitted from the profile server 120 to the first user device 100. Accordingly, the first user device 100 may allow the access to the content that is set to be blocked or the category where the content belongs.

When the second user device 130 rejects unblocking of the content that is set to be blocked or the category where the content corresponding to the request for blocking belongs in operation 411, the second user device 130 may transmit information associated with rejecting unblocking to the profile server 120 in operation 419. In operation 421, the profile server 120 may transmit, to the first user device 100, information associated with maintaining a blocking setting of the content that is set to be blocked or the category where the content belongs. Accordingly, the first user device 100 may maintain the blocking setting of the content corresponding to the request for unblocking. The first user device 100 may output information reporting that unblocking of the content corresponding to the request for unblocking is rejected.

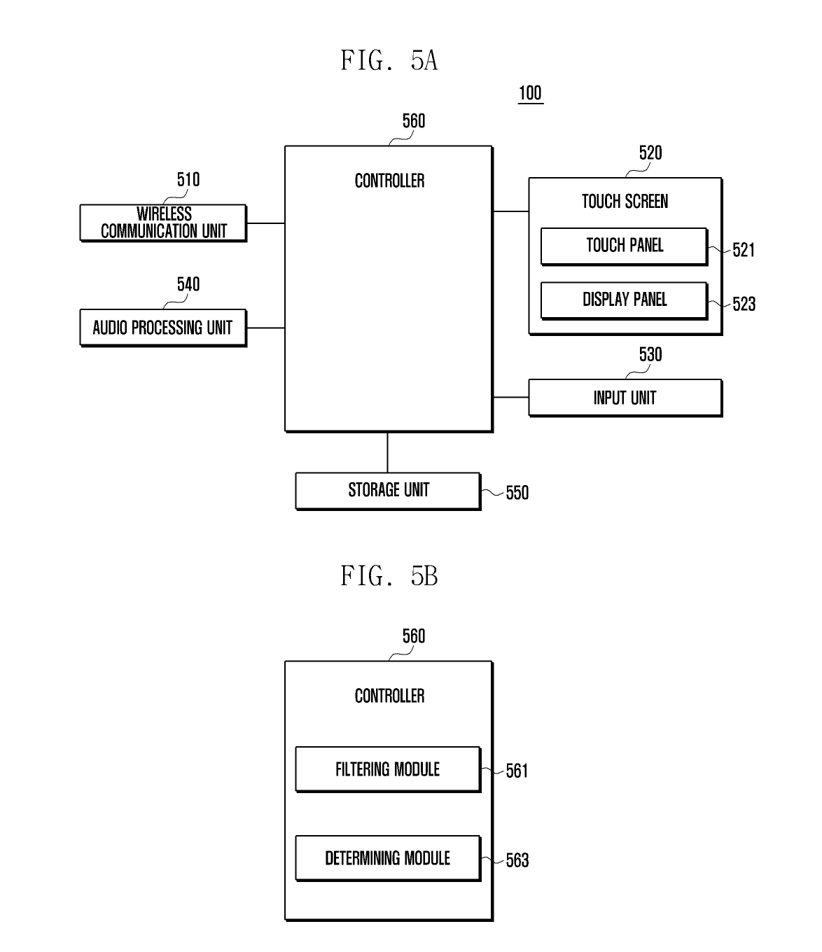

FIGS. 5A and 5B are block diagrams illustrating a first user device 100 according to an embodiment of the present invention. FIG. 5A is a block diagram of the first user device 100, and FIG. 5B is a block diagram of a controller 560 of the first user device 100.

Referring to FIGS. 5A and 5B, the first user device 100 may include a wireless communication unit 510, a touch screen 520, an input unit 530, an audio processing unit 540, a storing unit 550, and the controller 560.

The wireless communication unit 510 is a configuration that may be added when the first user device 100 is an electronic device that supports a communication function, and may be omitted when the first user device 100 does not support the communication function.

The wireless communication unit 510 may form a communication channel of a preset scheme with a network (a mobile communication network or the like) which may be supported under a control of the controller 560 to transmit/receive a signal related to wireless communication such as voice communication or video communication, and message service-based data communication such as a Short Message Service (SMS), a Multimedia Messaging Service (MMS), or the Internet. Further, the wireless communication unit 510 may include a transceiver for up-converting and amplifying a frequency of a transmitted signal, and low-noise amplifying and down-converting a frequency of a received signal. The wireless communication unit 510 may form a data communication channel for a message service to transmit/receive message service-based data under a control of the controller 560. In this case, the communication channel may include a mobile communication channel such as Code Division Multiple Access (CDMA), Time Division Multiple Access (TDMA), Orthogonal Frequency-Division Multiple Access (OFDMA), and the like, and an Internet communication channel such as a wired Internet network, a wireless Internet network, and the like.

In an embodiment of the present invention, the wireless communication unit 510 may transmit, to a content classification server, information associated with content corresponding to an access request, so as to determine a category where the content corresponding to the access request belongs. The wireless communication unit 510 may receive, from the content classification server, information associated with the category where the content corresponding to the access request belongs. The wireless communication unit 510 may transmit information for access to a file path and a URL where the content is located, so as to enable the access to the content when the category where the content corresponding to the access request belongs corresponds to a category that is not set to be blocked in a default policy and a modified policy. The wireless communication unit 510 may transmit, to a profile server, unblocking request information associated with the content that is set to be blocked, and may receive, from the profile server, the default policy, the modified policy, unblocking request allow information, and blocking setting maintain information.

The touch screen 520 may provide various screens required for operating the first user device 100. For example, the touch screen 520 may support an idle screen, a menu screen, an application execution screen, and the like, which are required for operating the first user device 100. The touch screen 520 may include a touch panel 521 and a display panel 523. The touch panel 521 may be implemented as an add-on type located on the display panel 523 or an in-cell type inserted into the display panel 523.

The touch panel 521 may generate a touch event in response to a user's touch gesture for the screen, perform an Analog-to-Digital (AD) conversion on the touch event, and transmit the touch event to the controller 560.

The display panel 523 may display data on the screen under control of the controller 560. For example, when the controller 560 processes data (for example, decodes data) and stores the data in a buffer, the display panel 523 may convert the data stored in the buffer to an analog signal and displays the converted data on the screen. The display panel 523 may display various screens according to the use of the portable electronic device 100, for example, a lock screen, a home screen, an application execution screen, a menu screen, a keypad screen, a message writing screen, an Internet screen, and the like.

The display panel 523 may be implemented as a Liquid Crystal Display (LCD), an Active Matrix Organic Light Emitted Diode (AMOLED), a Passive Matrix Organic Light Emitted Diode (PMOLED), a flexible display, or a transparent display.

The input unit 530 may be a configuration for generating various input signals required for operating the first user device 100. The input unit 530 may include various input devices such as a keyboard, a keypad, a key button, or the like, based on whether the first user device 100 is compatible. The input unit 530 may be configured in a form of a touch map that is output on a touch screen.

The audio processing unit 540 may output various audio data set while the first user device 100 operates, audio data generated as an audio file stored in the storage unit 550 is played back, audio data received from the outside, and the like. In an embodiment of the present invention, when content corresponding to an access request is blocked or a request for unblocking content is rejected, the audio processing unit 540 may output a notification sound or an effect sound corresponding to the event.

The storage unit 550 is a secondary memory unit of the controller 560 and may include a disk, a Random Access Memory (RAM), and a flash memory. The storage unit 550 may store data generated by the first user device 100 or data received from external devices, for example, a server, a desktop PC and the like via the wireless communication unit 510 or an external interface unit under control of the controller 560. Also, the storage unit 550 may store various data, such as video data, game data, music data, movie data, map data, and the like. In an embodiment of the present invention, the storage unit 550 may store a default policy and a modified policy received from the profile server. In addition, the storage unit 550 may include a cache for recording content that is blocked within a predetermined period.

The controller 560 may control general operations of the first user device 100 and a signal flow among internal components of the first user device 100, and may process data. For example, the controller 560 may be a Central Processing Unit (CPU), an Application Processor (AP), or the like. Further, the controller 560 may be a single core processor or a multi-core processor.

Referring to FIG. 5B, the controller 560, according to an embodiment of the present invention, may include a filtering module 561 and a determining module 563. The filtering module 561 may block a content corresponding to an access request when a category where the content corresponding to the access request belongs is a category that is set to be blocked in the default policy or the modified policy. In addition, when access to content having a record of being blocked within a predetermined period is requested, the filtering module 561 may immediately block the content without determining a category where the content corresponding to the access request belongs. Although FIG. 5B illustrates that the filtering module 561 is included in the controller 560, it may be configured as a separate module from the controller 560. The filtering module 561 may block access to a file path or a URL where the content corresponding to the access request is located, based on a header file and an actual data content included in a packet that passes through the filtering module 561.

The filtering module 563 may determine whether the category where the content corresponding to the access request belongs is identical to a category that is set to be blocked in the default policy or the modified policy. In particular, when an input for accessing content is received from a user via the input unit 530 or the like, the filtering module 561 may transfer the related information to the determining module 563, and the determining module 563 may execute a control to transmit the input information to the content classification server so as to determine the category where the content corresponding to the access request belongs. The determining module 563 may determine the conformity of the category by comparing the category where the content corresponding to the access request belongs with the default policy or the modified policy in the content classification server. When it is determined that the category where the content corresponding to the access request belongs is identical to a category set in the default policy or the modified policy, the determining module 563 may transfer the information for blocking the content corresponding to the access request to the filtering module 561. When a request for unblocking the content corresponding to the access request exists, the determining module 563 may determine transmission of unblocking request information to the profile server. In addition, when information for allowing unblocking the content corresponding to the request for unblocking, is received from the profile server, the determining module 563 may transfer, to the filtering module 561, information for allowing access to the content. Conversely, when information for rejecting the request for unblocking is received from the profile server, the determining module 563 may transfer, to the filtering module 561, information for blocking the content corresponding to the request for unblocking.

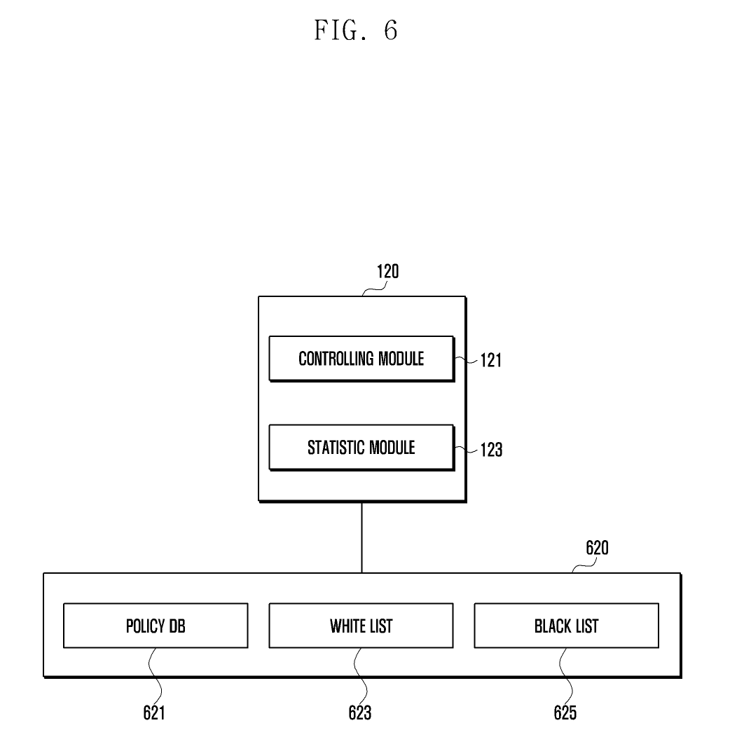

FIG. 6 is a diagram illustrating a profile server according to an embodiment of the present invention. Although FIG. 6 illustrates the profile server 120 and the profile database 620 separately, the profile database 620 may be integrated with the profile server 120.

Referring to FIG. 6, the profile server 120 may include a controlling module 121 and a statistic module 123.

The controlling module 121 controls general operations of the profile server 120 and a signal flow among internal components of the profile server 120, and processes data. The controlling module 121, according to an embodiment of the present invention, may set and manages a default policy. In particular, the controlling module 121 may set the default policy by reflecting various characteristics. In other words, the profile server 120 may set the default policy by reflecting a regional division, for example, an administrative district such as a nation, a city, a province, and the like, and a cultural region division based on a predetermined cultural characteristic, and detailed characteristics such as an age, a gender, an occupation, a religion, and the like of users of a first user device 100 and a second user device 130.

In addition, the controlling module 121 may set the default policy for each group. In particular, the controlling module 121 may execute a control so as to set the default policy by classifying the at least one first user device 100 based on a group when the at least one first user device 100 is managed by the second user device 130 based on a group. In addition, the controlling module 121 may control a flow of information between the first user device 100 and the second user device 130. For example, the controlling module 121 may execute a control so as to transmit the default policy to the first user device 100 via a communication unit of the profile server 120, to receive unblocking request information from the first user device 100, and to transmit the same to the second user device 130. In addition, the controlling module 121 may transmit the default policy to the second user device 130 and may receive a modified policy. The default policy and the modulated policy may be stored in a policy database 621 of the profile database 620.

The statistic module 123 may update the default policy. In particular, the statistic module 123 may update the default policy based on a white list 623, a black list 625, or the like, during a predetermined period. In this case, the white list 623 may store information associated with a content that is allowed, by the second user device 130, to be unblocked or a category where the content belongs, information associated with a category that is allowed to be unblocked based on the modified policy received from the second user device 130, and the like. The black list 625 may store information associated with a category of which a setting that has allowed the access is changed into a blocking setting based on the modified policy from the second user device 130, information associated with a category of which blocking is requested separately by the second user device 130, and the like. The statistic module 123 may compare the number of times of changing a blocking setting of a predetermined category of which a blocking setting has changed in a predetermined period, with other categories, and may reflect the same to the default policy, so as to update the default policy.

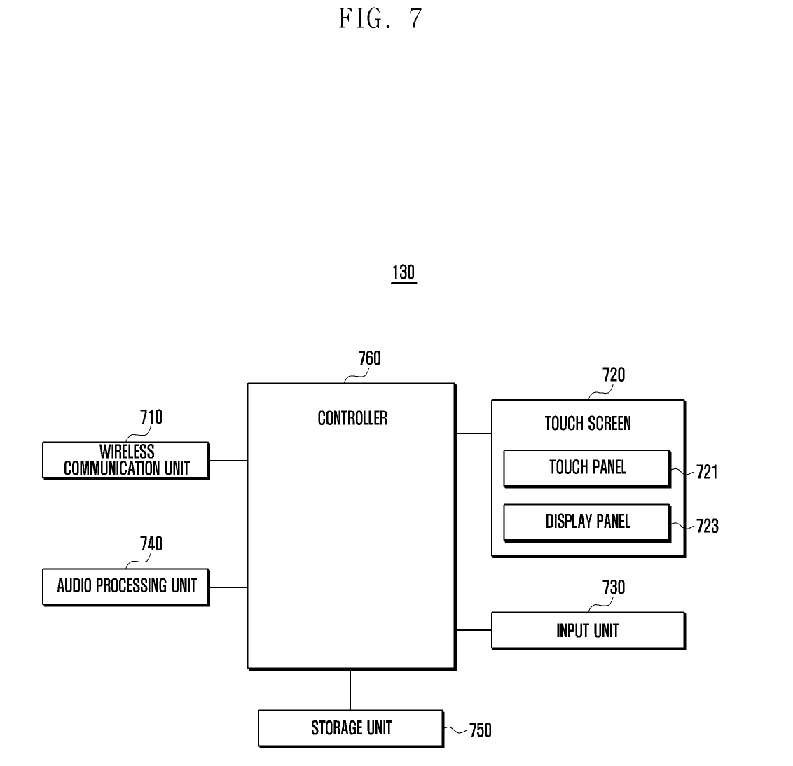

FIG. 7 is a block diagram illustrating a second user device 130 according to an embodiment of the present invention.

Referring to FIG. 7, the second user device 130 may include a wireless communication unit 710, a touch screen 720, an input unit 730, an audio processing unit 740, a storing unit 750, and a controller 760. Descriptions of the functions of the second user device 130, which are identical to the first user device 100, are omitted.

The wireless communication unit 710 may receive a default policy from a profile server, and transmits a modified policy, under control of the controller 760. The touch screen 720 may include a touch panel 721 and a display panel 723. The touch screen 720, according to an embodiment of the present invention, may display the default policy provided in a form of a list including a category that is set to be blocked or is allowed to be accessed, so as to modify the default policy under control of the controller 760. For example, the touch screen 720 may display a check box for checking whether to block at least one piece of content category information and category information. In addition, the touch screen 720 may display the default policy based on a group, under a control of the controller 760. Through the above, the second user device 130 may manage at least one first user device 100. In addition, the input unit 730 may receive an input from a user of the second user device 130, separately from or being integrated with the touch screen 720. For example, when a request for unblocking content that is set to be blocked is received from the first user device 100 via the profile server 120, the user may input information for allowing or rejecting the request for unblocking via the input unit 730.

The storage unit 750 is a secondary memory unit of the controller 760 and may include a disk, a RAM, and a flash memory. The storage unit 750 may store data generated by the second user device 130 or data received from external devices, for example, a server, a desktop PC and the like via the wireless communication unit 710 or an external interface unit under control of the controller 760.

The controller 760 may control general operations of the second user device 130 and a signal flow among internal components of the second user device 130, and may process data. For example, the controller 760 may be a Central Processing Unit (CPU), an Application Processor (AP), or the like. Further, the controller 760 may be a single core processor or a multi-core processor.

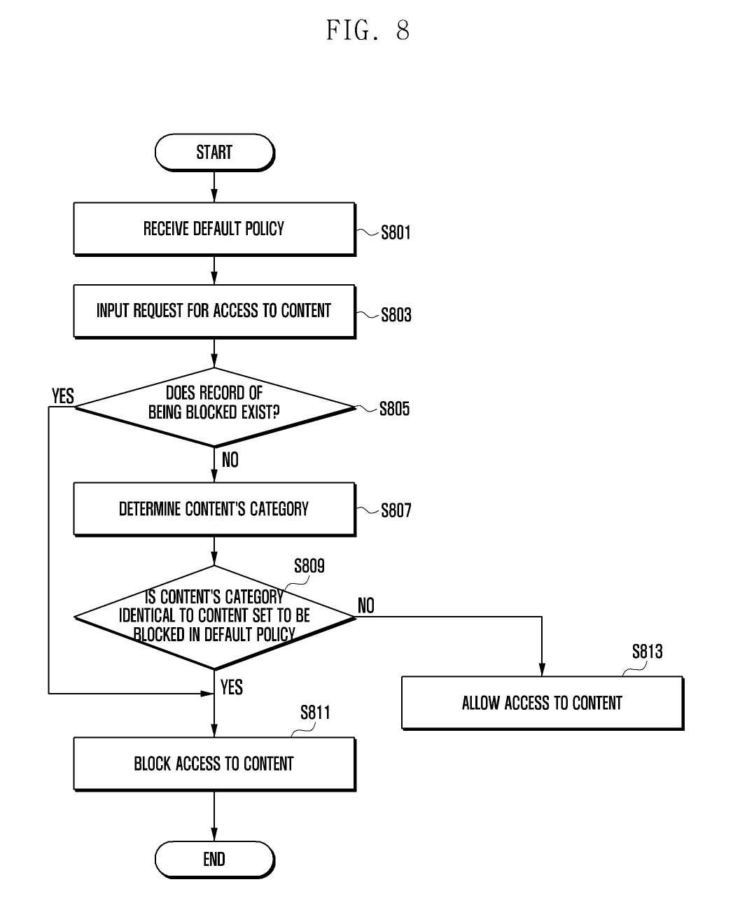

FIG. 8 is a flowchart illustrating a content blocking method of the first user device 100 according to an embodiment of the present invention.

Referring to FIG. 8, in operation 801, the controller 560 of the first user device 100 may receive a default policy from the profile server 120. The default policy may be provided in a form of a list including information associated with whether to block a category for each category. Although not illustrated in FIG. 8, before operation 801, a user of the first user device 100 may transmit, to the profile server 120, information associated with the first user device 100 and user information of the first user device 100, for example, a region of residence, an age, and the like, for subscribing for or registering on a content blocking service according to an embodiment of the present invention.

In operation 803, the controller 560 may receive an input for accessing content. For example, the user of the first user device 100 may execute an application, an Internet browser, and the like and may input a file path or a URL where predetermined content is located, so as to access the predetermined content.

In operation 805, the controller 560 may determine whether the content corresponding to the access request has a record of being blocked within a predetermined period. For example, access to a predetermined file path or a URL where the desired content is located is attempted again within a predetermined period, the controller 560 may immediately block the content corresponding to the access request without a process of determining a category associated with the content corresponding to the access request and comparing based on the default policy. In this case, the record of being blocked within a predetermined period may be stored in a cache or the like. When the determination in operation 805 shows that the content corresponding to the access request has a record of being blocked within a predetermined period, the controller 560 may immediately block the content corresponding to the access request without determining the category where the content corresponding to the access request belongs in operation 811.

Conversely, when the determination in operation 805 shows that the content corresponding to the access request has a record of being blocked within a predetermined period, the controller 560 may reserve the determination on whether to block the content, and may determine the category where the content belongs in operation 807. In particular, the controller 560 may transmit content information of the content corresponding to the access request to the content classification server 110, so as to determine the category where the content corresponding to the access request belongs. The controller 560 receives information associated with the category where the content corresponding to the access request belongs from the content classification server 110, and may determine the category where the content corresponding to the access request belongs based on the information.

In operation 809, the controller 560 compares the category where the content belongs with the default policy, so as to determine whether the category including the content is a category set to be blocked in the default policy.

When it is determined that the category including the content is a category set to be blocked in the default policy in operation 809, the controller 560 may block the content corresponding to the access request, that is, may block the access to a file path or a ULR where the content corresponding to the access request is located, in operation 811. For example, when it is determined that the URL where the content corresponding to the access request is located belongs to a drug category and the drug category is set to be blocked in the default policy, the controller 560 may block the access to the URL where the content corresponding to the access request is located.

Conversely, when it is determined that the category where the content belongs is a category that is not set to be blocked in the default policy in operation 809, the controller 560 may allow the access to the category corresponding to the access request in operation 813.

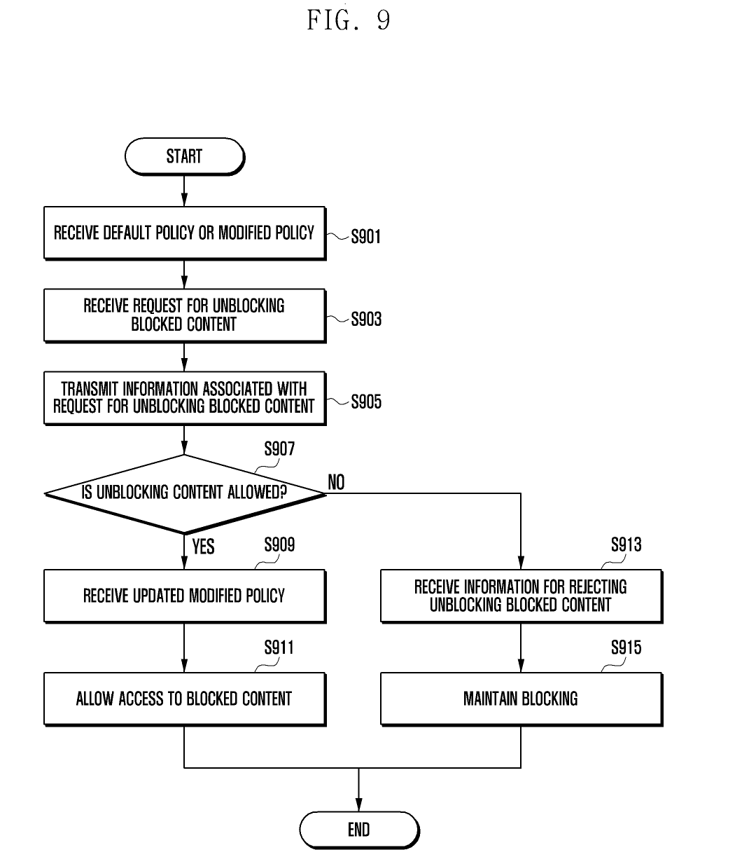

FIG. 9 is a flowchart illustrating a content blocking method of the first user device 100 according to an embodiment of the present invention.

Referring to FIG. 9, in operation 901, the controller 560 of the first user device 100 may receive a default policy or a modified policy. In particular, the controller 560 may receive the default policy from the profile server 120, or may receive, from the profile server 120, a modified policy that is modified by the second user device 130 from the default policy.

In operation 903, the controller 560 may receive a request for unblocking content that belongs to a category that is set to be blocked in the default policy or the modified policy. In operation 905, the controller 560 may transmit the received request for unblocking to the second user device 130 via the profile server 120. Although not illustrated in FIG. 9, when the controller 560 determines that the content corresponding to the request for unblocking is included in a category that is set to be blocked or that the content corresponding to the request for unblocking has a record of being blocked within a predetermined period, the controller 560 may transmit information associated with the content corresponding to the request for unblocking to the second user device 130 via the profile server 120.

When the second user device 130 allows the request for unblocking the content corresponding to the request for unblocking, transferred from the profile server 120, in operation 907, the controller 560 may receive a modified policy or a re-modified policy that unblocks the content that is set to be blocked or the category including the content that is set to be blocked, in operation 909. Accordingly, the controller 560 may execute a control so as to unblock the content that is set to be blocked, and allows access in operation 911.

Conversely, when the second user device 130 rejects the request for unblocking the content corresponding to the request for unblocking, transferred from the profile server 120, in operation 907, the controller 560 may receive, from the profile server 120, information for rejecting the content corresponding to the request for unblocking in operation 913. Accordingly, the controller 560 may maintain a blocking setting for the content corresponding to the request for unblocking, or may block the content when access is requested.

As described above, according to embodiments of the present invention, the content controlling system 10 and method have various criteria for classifying objectionable content, and adaptively update the criteria for objectionable content through feedback with a user, so as to effectively filter objectionable content.

The embodiments disclosed in the present specifications and drawings were provided merely to readily describe and to facilitate a thorough understanding of the present invention but are not intended to limit the scope of the present invention. Therefore, it should be construed that all modifications or modified forms drawn by the technical idea of the present invention in addition to the embodiments disclosed herein are included in the scope of the present invention as defined by the appended claims, and their equivalents.

What is claimed is:

1. A method of a user device to block content, the method comprising:
receiving a policy from a profile server;
receiving a content access request;
determining a category where content corresponding to the access request belongs; and
blocking the content corresponding to the access request, if the determined category corresponds to a category that is set to be blocked in the policy.

2. The method of claim 1, wherein the policy is set based on the user device or at least one of a location, a culture, an age, a gender, an occupation, and a religion of a user of the user device.

3. The method of claim 1, wherein determining the category where the content corresponding to the access request belongs comprises:
transmitting, to a content classified server, information associated with the content corresponding to the access request; and
receiving, from the content classification server, information associated with a category where the content corresponding to the access request belongs from the content classification server.

4. The method of claim 1, further comprisingblocking the content corresponding to the access request, when the content has a record of being blocked within a predetermined period.

5. The method of claim 1, wherein receiving the policy from the profile server comprises receiving a modified policy, which is obtained through modifying the policy by another user device.

6. The method of claim 1, further comprising:
receiving a request for unblocking associated with the content that belongs to the category that is set to be blocked in the policy; and
transmitting, to another user device, the received request for unblocking via the profile server.

7. The method of claim 6, further comprising,transmitting, by another user device, information associated with permission or rejection of the request for unblocking when the request for unblocking is allowed or rejected by the another user device.

8. The method of claim 7, further comprising:
storing, by the profile server, information associated with content for which the request for unblocking is allowed and a category that includes the content for which the request for unblocking is allowed;
receiving, from the profile server, the information associated with the content for which the request for unblocking is allowed and the category that includes the content for which the request for unblocking is allowed; and
allowing access to the content corresponding to the request for unblocking.

9. The method of claim 7, further comprisingupdating the policy based on the stored information associated with the content for which the request for unblocking is allowed and the category that includes the content for which the request for unblocking is allowed, during a predetermined period.

10. The method of claim 1, wherein the policy is set to be different based on a group where the user device belongs.

11. A content blocking system, comprising:
a profile server configured to set a policy and transmit the set policy; and
a first user device configured to receive the set policy from the profile server, receive a content access request, determine a category where content corresponding to the access request belongs, and block the content corresponding to the access request, if the determined category corresponds to a category that is set to be blocked in the policy.

12. The content blocking system of claim 11, wherein the policy is set based on the first user device, or at least one of a location, a culture, an age, a gender, an occupation, and a religion of a user of the first user device.

13. The content blocking system of claim 11, further comprising:
a content classification server configured to receive information associated with the content corresponding to the access request from the first user device, search for information associated with the category where the content corresponding to the access request belongs, and transmit, to the first user device, the retrieved information associated with the category where the content corresponding to the access request belongs,
wherein the first user device determines the category where the content corresponding to the access request belongs based on the retrieved information associated with the category where the content corresponding to the access request belongs.

14. The content blocking system of claim 11, wherein the first user device blocks the content corresponding to the access request, when the content has a record of being blocked within a predetermined period.

15. The content blocking system of claim 11, further comprising a second user device configured to manage the first user device and set a modified policy obtained through modifying the policy.

16. The content blocking system of claim 11, wherein the first user device is further configured to receive a request for unblocking associated with content that belongs to the category that is set to be blocked in the policy, and transmit the received request for unblocking to the second user device via the profile server.

17. The content blocking system of claim 16, wherein, when the second user device allows or rejects the request for unblocking, and wherein the second user device is further configured to transmit, to the profile server, information associated with the permission or rejection for the request for unblocking.

18. The content blocking system of claim 17, wherein the profile server is further configured to store information associated with content for which the request for unblocking is allowed and a category that includes the content for which the request for unblocking is allowed, and
Wherein the first user device is further configured to receive, from the profile server, the information associated with the content for which the request for unblocking is allowed and the category that includes the content for which the request for unblocking is allowed, and allow access to the content corresponding to the request for unblocking.

19. The content blocking system of claim 17, wherein the profile server is further configured to update the policy based on the stored information associated with the content for which the request for unblocking is allowed and the category that includes the content for which the request for unblocking is allowed, during a predetermined period.

20. The content blocking system of claim 11 , wherein the policy is set to be different based on a group where the first user device belongs.
